(19) United States
(12) Patent Application Publication
(10) Pub. No.: US 2002/0111526 A1
(43) Pub. Date: Aug. 15, 2002

(54) Removal of noxious substances from gas streams

(76) Inventor: Andrew James Seeley, Bristol (GB)

Correspondence Address: The BOC Group, Inc., Intellectual Property Department, 100 Mountain Avenue, New Providence, NJ, 07974, US

(21) Appl. No.: 10/002,668

(22) Filed: Oct. 31, 2001

(30) Foreign Application Priority Data
Nov. 1, 2000 (GB) 0026697.3

(51) Int. Cl. A62D 3/00

(52) U.S. Cl. 588/205

(57) ABSTRACT

A process for the combustive destruction of noxious substances in a gas stream which comprises injecting the gas stream into a heated chamber with sufficient oxygen to allow substantially complete combustion therein, wherein hydrogen is also present in the chamber as a fuel gas.

### FIELD OF THE INVENTION

This invention relates generally to the removal of noxious substances from gas streams, and in particular to the removal of very stable fluorocarbons from gas streams emanating from semi-conductor processing chambers by means of combustion.

### BACKGROUND OF THE INVENTION

Many substances used in semi-conductor device manufacturing, and which are extracted from a chamber in which such manufacturing takes place, are toxic and/or environmentally harmful and must therefore be scrubbed from the exhaust gas stream before its release into the atmosphere.

A number of different types of wet or dry chemical scrubbing reactors have been proposed and numerous are commercially employed in the semi-conductor industry.

For example, in Patent Specification No. WO 89/11905 there is disclosed a dry chemical reactor sold by BOC Edwards Division comprising a heated packed tube of granular substances through which the exhaust stream is directed including in particular a first stage of silicon (with an optional addition of copper when the exhaust stream contains nitrogen trifluoride in particular) and a second stage of calcium oxide commonly in the form of lime. Such a reactor has met with considerable commercial success for the scrubbing of such toxic substances.

It is also known from European Patent Specification No 694 735 in the name of Alzeta Corporation, and European Patent Specification No. 0 802 370 that noxious substances of the type in question can be removed from exhaust streams by combustion.

These specifications describe processes for the combustive destruction of noxious substances and which comprise injecting an exhaust gas and added fuel gas in to a combustion zone that is laterally surrounded by the exit surface of a foraminous gas burner, simultaneously supplying fuel gas and air to the burner to effect combustion at the exit surface, the amount of the fuel gas supplied to the foraminous gas burner being on a BTU basis, greater than that of the added fuel gas, and the amount of the air being in excess of the stoichiometric requirement of all the combustibles entering the combustion zone, and discharging the remitting combustion product stream from the combustion zone.

A central feature of the earlier of these combustive processes is the critical need to supply the fuel gas admixed with the exhaust gas stream into the combustion zone of the burner. Such premixing of the fuel gas and exhaust gas streams allows for a much greater and efficient scrubbing of the perfluorocarbon hexafluoroethane (C₂F₆). However, there remain certain problems associated with the scrubbing of the even more stable perfluorocarbon, tetrafluoromethane (CF₄).

A great advantage of the combustive scrubbing process described above is that it inherently limits the maximum temperature that can be attained in the combustion chamber and thereby suppress the formation of NOₓ gas by-products that may otherwise be formed.

However, in the later of these processes, it was found that an addition of oxygen to the exhaust gas stream prior to the introduction of the gas stream in to a foraminous gas burner generally allows for a more efficient combustion of perfluorocarbon gases including tetrafluoromethane (CF₄) in particular.

It is known that stable perfluorocarbons and other stable global warming compounds such as nitrogen trifluoride (NF₃) and sulphur hexafluoride (SF₆) can be destroyed in combustion type abatement systems described in the above-referenced specifications. The underlying principle of the approach in these prior specifications is to form a premixed flame from a mixture of the process gas to be abated (substantially nitrogen but containing a low percentage by volume of the perfluoro compound), oxygen and a hydrocarbon fuel. The fuel and oxygen are added separately and in such a manner as to prevent intermixing except immediately prior to their introduction into the combustion chamber in order to minimize any possibility of flashing back. This is preferentially achieved by premixing either the fuel or the oxygen with the process exhaust gas and adding the other component via a lance mounted concentrically within the nozzle through which the gases enter the combustion chamber. The combustion chamber itself is formed from the exit surface of a foraminous gas burner. This provides (by means of the surface combustion) the necessary thermal and chemical environment to support the combustion of the perfluoro compounds within the previously mentioned premixed flame.

For the abatement of less stable compounds such as hydrides, acid halides, etc, abatement systems employing in part electrically heated chambers of metallic construction operating at moderate temperatures (500° C. to 800° C.) have commonly been employed. The destruction of perfluoro compounds in an apparatus of this type has been demonstrated by the co-addition of fuel and oxygen to the reaction chamber along with the process exhaust gas. A substantially increased operating temperature (about 1000° C.) has proven necessary to provide acceptable destruction rates. However, the drawbacks of this approach include the production of large quantities of nitrogen oxides (NOₓ) as well as reduced component lifetime as a result of the prolonged operation at elevated temperatures within a very corrosive environment.

### SUMMARY OF THE INVENTION

The invention is concerned with the provision of a new combustive process and apparatus which allow for the destruction of perfluoro compounds and other compounds at temperatures substantially below those previously repeated and with negligible production of NOₓ.

### BRIEF DESCRIPTION OF THE DRAWINGS

FIG. 1 is a schematic representation in an elevated sectional view of the apparatus for conducting the process of the present invention.

### DETAILED DESCRIPTION OF THE INVENTION

In accordance with the present invention, there is provided a process for the combustive destruction of noxious substances in a gas stream which comprises injecting the gas stream in to a heated chamber with sufficient oxygen to allow substantially complete combustion therein, wherein hydrogen is also present in the chamber as a fuel gas.

In preferred embodiments, the process of the invention provides for the combustive destruction of noxious substances in a gas stream which comprises one or more nozzles (generally one for each process exhaust stream) through which the stream (or streams) discharges in to a heated combustion chamber.

Preferably the chamber comprises a heated metal tube, for example copper or stainless steel. Heating of the chamber is preferably effected by electrical means, i.e. an electrical resistance heater or heaters being placed around the chamber with means being provided to insulate the external surfaces of the chamber.

It is important that both the fuel gas and the oxygen are introduced in to the gas stream prior to the stream being injected in to the chamber. The resultant flammable mixture is caused to ignite, generally resulting in a substantially attached premixed flame which is adjacent to (or “anchored” to) the end of the nozzle or nozzles. This provides for the destruction of the perfluorocarbon gases present within the combusting mixture. The background temperature of the combustion chamber provides both the initial source of ignition and the means to minimize radiative heat loss from the extremities of the flame, hence maximising destruction efficiency for a given fuel input.

The structure of the inlet nozzles is advantageously designed as to give a mean forward gas velocity sufficient to prevent the back migration of a flame up the nozzle, but not so high as to cause the flame to lift off the end of the nozzle. This is typically achieved by causing the forward gas velocity to be between two and five times the characteristic burning velocity for the pre-mixed concentrations of fuel, oxygen and diluent gas. The efficiencies possible with a construction of this arrangement are in marked contrast to those typically observed where the separate reactive components are caused to intermix and subsequently burn unsupported within a heated combustion chamber.

Preferably the oxygen is introduced in to the gas stream by way of an oxygen lance. Preferably a nozzle or nozzles of such a lance are positioned to introduce the oxygen in to the gas stream substantially immediately prior to the point of injection of the gas stream in to the heated chamber.

With regard to the fuel gas, this can be added to the gas stream at any convenient point prior to the entry of the gas stream in to the heated chamber. However, for reasons of flammability in particular, both the oxygen and the fuel gas should not be present together for any appreciable time prior to their co-injection in to the heated chamber. Overall, it is advantageous for the fuel gas to be injected in to the gas stream upstream of the point of injection of the oxygen.

The resulting gas mixture is injected in to the heated chamber and contains a fuel gas and oxygen (or air). Advantageously, the mixture should have a 10% to 150% stoichiometric excess of oxygen over the fuel gas, more advantageously from 80% to 150%.

Hydrogen, which is generally not a suitable fuel for a porous ceramic burner has been found to be suitable for use as an inject fuel in the manner described previously and is readily available. Furthermore, the hydrogen and oxygen inject are preferably only required when the perfluorocarbons gas is present and to be abated. Gas streams not containing perfluorocarbon do not necessarily require such an inject.

The source of hydrogen may be the pure or substantially pure gas or may be a hydrogen mixture such as “water gas” or “synthesis gas” formed from the interaction of steam with carbonaceous materials at elevated temperatures and having a typical composition of 45% H₂, 45% CO by volume, balance N₂, CO₂, CH₄. Alternatively, a mixture of hydrogen and nitrogen can be employed, for example 75% H₂, balance substantially nitrogen (by volume).

The amount of hydrogen itself present in the process is preferably at least the stoichiometric amount (by volume) in respect of the species being combusted. For example, in the case of fluorine compounds, the amount of hydrogen is preferably at least the stoichiometric amount in respect of the free and the coordinated fluorine. In the case of fluorine (F₂) itself, at least the same volumes of fluorine and hydrogen (H₂) would be required. In the case of nitrogen trifluoride (NF₃) there would be 1.5 volumes of hydrogen to each volume of NF₃.

In the case of the perfluorocarbon hexofluorine ethane (C₂F₆), there would be at least three hydrogen volumes for each C₂F₆ volumes.

The amount of hydrogen present is beneficially at least twice or three times, or even five or ten times, the stoichiometric volume in respect of the species being combusted.

In preferred embodiments, the apparatus in which the process of the invention is conducted can be adapted so that a gas stream emanating from a processing chamber, for example a semi-conductor chamber can be interfaced with a process tool contained in the chamber to monitor and thereby ascertain when perfluorocarbon gases are present in the gas stream leaving the chamber and, normally via a vacuum pump or pumps evacuating the chamber, being urged forward and injected in to the heated chamber of the apparatus for conducting the invention. This monitoring can lead to a substantially reduced usage of fuel gas and oxygen, and consequential reduction in cost, as the inject of these gases can be turned off when no perfluorocarbon gases are present.

In accordance with the invention, the generation of the gas stream/oxygen/fuel gas mixture within the thermal environment provided by heated reactor can lead to the destruction of perfluoro compounds at temperatures generally substantially below those previously disclosed and with negligible production of NOₓ. This is particularly useful in situations where there is no readily available source of gaseous hydrocarbon fuel. The thermal environment should preferably be provided electrically.

For a better understanding of the invention, reference will now be made, by way of exemplification only, to the accompanying drawing which shows a schematic representation of apparatus for conducting the process of the invention.

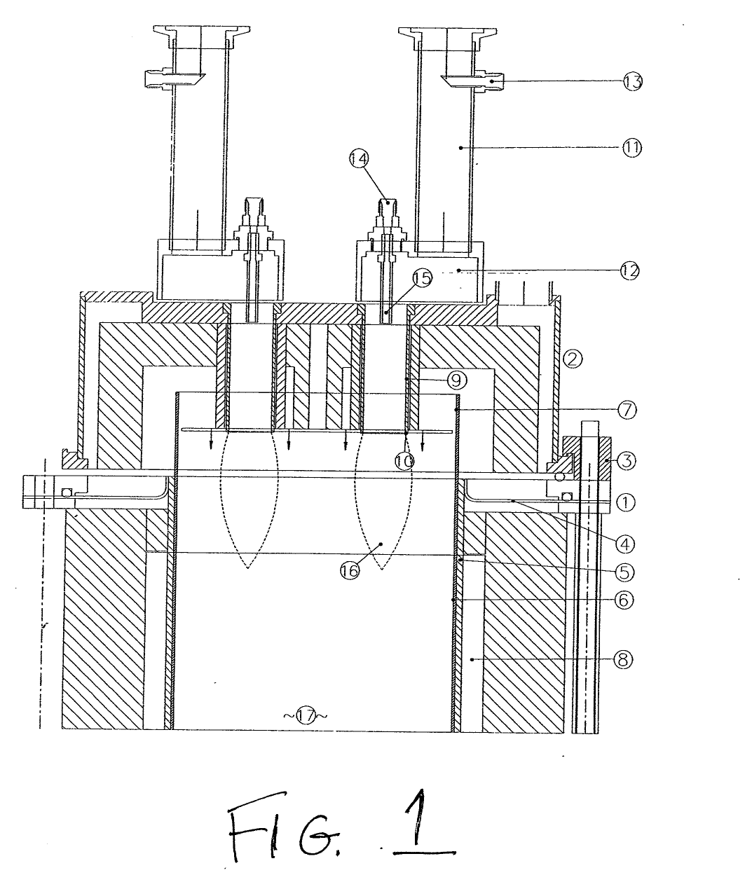

With reference to FIG. 1, there is shown an apparatus of the present invention having an overall cylindrical shape and comprising a lower body portion 1 and an upper body portion 2 secured (and sealed) to each other by fixing means 3.

Centrally held within the lower body portion 1 by means of a spacer ring 4 is a tubular wall member 5 of good thermal conductivity. A reaction chamber 6 of cylindrical shape and made of copper or stainless steel is provided and sized such that it fits closely with the wall member 5 and an upper end 7 thereof extends from within the wall member 5 and into the interior of the upper body portion 2.

An electrical resistance heater 8 is present in the annular space between the lower body portion 1 and the wall member 5 and adapted for the efficient heating of the wall member 5 and hence the reaction chamber 6.

Four inlet nozzles 9 (two of which are shown in FIG. 1 with the other two hidden behind) are securely held (and sealed) in the upper body portion 2, the lower ends 10 of which extend into the confines of the upper end 7 of the reaction chamber 6.

Four process gas inlet tubes 11 are present and are linked to their respective inlet nozzle 9 via one of four intermediate chambers 12 to form four sealed passageways between the respective inlet tubes 11 and inlet nozzles 9.

Towards the top of each inlet tube 11 is an oxygen inject port 13 extending substantially to the center line of tube 11.

A fuel gas injection port 14 is present in each intermediate chamber 12 with a lance 15 extending through chamber 12 and into the top area of the inlet nozzle 9.

In use of the apparatus, an exhaust gas stream from for example, a semi-conductor processing chamber is urged for example, by means of a vacuum pump system in one of the inlet tubes 11 and is thereafter injected in to the confines of the reaction chamber 6. Oxygen (or air) is introduced into the gas stream as it passes through the tube 11 by means of the inject port 13 and fuel gas is introduced in to the oxygen-containing gas stream as it passes through the inlet nozzle 9 by means of the lance 15.

One or more of the inlet tubes may be connected to gas streams emanating from one or more process chamber as appropriate.

In use, the reaction chamber 6 is heated by means of the heater 8 to produce the desired temperature within and across the chamber. The presence of the oxygen and the fuel gas will generally cause a flame 16 to appear at the end 10 of the inlet nozzle 9 as indicated by the dotted lines within the chamber 6.

Supplementary scrubbing means including a wet scrubber may be attached to the exit 17 of the reaction chamber 6.

In process tests conducted in the apparatus in accordance with the present invention, one of the four inlet tubes 11 was connected to the exhaust of a vacuum pump from a semiconductor processing chamber. The pump was equipped with facilities to monitor the flow rates of perfluorocarbon compounds and to vary the total nitrogen flow. Injections of hydrogen fuel gas and oxygen were introduced as indicated.

The other three inlet tubes 11 were each connected to a source of nitrogen at 50 sl/min to simulate the exhaust flows from three other vacuum pumps. The reaction chamber was heated to a tube temperature of 750° C.

The results are shown in Table I.

TABLE I

| Test | N₂ | H₂ | O₂ | | | % |
|---|---|---|---|---|---|---|
| # | l/min | l/min | l/min | PFC | l/min | Destruction |
| 1 | 37 | 10 | 5 | C₂F₆ | 1.2 | 82 |
| 2 | 27 | 10 | 5 | C₂F₆ | 1.2 | 92 |
| 3 | 27 | 10 | 4 | C₂F₆ | 1.2 | 92 |
| 4 | 27 | 10 | 3 | C₂F₆ | 1.2 | 88 |
| 5 | 50 | 10 | 5 | SF₆ | 1.3 | 62 |
| 6 | 40 | 10 | 5 | SF₆ | 1.3 | 72 |
| 7 | 35 | 10 | 5 | SF₆ | 1.3 | 77 |
| 8 | 27 | 10 | 5 | SF₆ | 1.3 | 82 |

In these results, the NOₓ emissions were 3 to 6 ppm maximum.

When using nitrogen trifluoride plasmas in semiconductor processing, especially those generated in remote plasma sources, high levels of fluorine gas can be produced.

Further process tests were conducted in a apparatus shown in the drawing again with the reactor chamber (internal) temperature of 750° C. The quantification of the nitrogen trifluoride was carried out using a “VG” mass spectrometer.

The flows of hydrogen, oxygen and reactive gases (NF₃, F₂) were controlled using a Tylan mass flow controllers. Nitrogen purge flows were measured using rotameters.

The results are shown in Table II.

TABLE II

| | Pump | Oxygen | Hydrogen | | Exhaust | Exhaust | Exhaust | |
|---|---|---|---|---|---|---|---|---|
| NF₃ flow | Nitrogen* | flow | Flow | NF₂ + | Oxygen | NO | NO₂ | % NF₃ |
| sl/min | sl/min | sl/min | Sl/min | Signal | (%) | (ppm) | (ppm) | destroyed |
| 0.48 | 45 | 5 | 10 | 1.48E−10 | | | | 95.6% |
| 0.48 | 45 | 0 | 10 | 1.10E−10 | | | | 96.7% |
| 0.48 | 45 | 0 | 20 | 1.76E−11 | | | | 99.5% |
| 0.48 | 45 | 10 | 20 | 2.35E−12 | 7 | 1811 | 103 | 99.9% |
| 0.48 | 45 | 5 | 20 | 1.53E−12 | 4.8 | 890 | 23 | 100.0% |
| 0.48 | 45 | 4 | 20 | 1.73E−12 | 4.4 | 385 | 14 | 99.9% |
| 0.48 | 45 | 3 | 20 | 8.56E−13 | 4 | 47 | 14 | 100.0% |
| 0.48 | 45 | 3.5 | 20 | 1.36E−12 | 4.2 | 127 | 15 | 100.0% |
| 0.48 | 45 | 2.5 | 20 | 7.39E−12 | 3.9 | 17 | 13 | 99.8% |
| 0.48 | 45 | 0 | 0 | 3.38E−09 | | | | 0.0% |

*at a first inlet tube 11. (50 sl/min N₂ provided to each of the other three inlets).

More tests were carried out in a similar manner during which the level of, and abatement of, fluorine was measured. The fluorine was measured using Dräger tubes.

The results are shown in Table III.

TABLE III

| NF₃ | Pump | Fluorine | Oxygen | Hydrogen | NF₂ + | Fluorine | % NF₃ |
|---|---|---|---|---|---|---|---|
| flow sl/min | Purge sl/min | flow sl/min | flow sl/min | flow sl/min | signal | ppm | destroyed |
| 1 | 35 | 0 | 0 | 0 | 6.28E−09 | | 0.00% |
| 1 | 45 | 1 | 4 | 9 | 2.05E−10 | ˜1 ppm | 96.73% |
| 1 | 35 | 1 | 4 | 9 | 7.48E−11 | ˜1 ppm | 98.81% |
| 1 | 35 | 1 | 4 | 13.3 | 6.29E−12 | ˜1 ppm | 99.90% |

These tests show good destruction of nitrogen trifluoride and fluorine with reasonable quantities of hydrogen being required.

Although the present invention has been described with reference to preferred embodiments, those skilled in the art will recognize that changes can be made in form and detail without departing from the spirit and scope of the invention.

I claim:

1. A process for the combustive destruction of noxious substances in a gas stream which comprises injecting the gas stream in to a heated chamber with sufficient oxygen to allow substantially complete combustion therein, wherein hydrogen is also present in the chamber as a fuel gas.

2. A process according to claim 1 in which the chamber comprises a heated metal tube.

3. A process according to claim 1 or claim 2 in which the chamber is heated by electrical means.

4. A process according to any preceding claim in which the hydrogen and the oxygen are introduced in to the gas stream prior to the stream being injected in to the chamber.

5. A process according to any preceding claim in which the mixture has a 10 to 150% stoichiometric excess of oxygen over the fuel gas.

6. A process according to claim 5 in which the mixture has an 80 to 150% stoichiometric excess of oxygen over the fuel gas.

7. A process according to any preceding claim in which the hydrogen is present in at least the stoichiometric amount by volume in respect of the species being combusted.

8. A process according to claim 7 in which the hydrogen is present in at least twice the stoichiometric amount by volume in respect of the species being combusted.

9. A process according to claim 7 or claim 8 in which the hydrogen is present in at least five times the stoichiometric amount by volume in respect of the species being combusted.

10. The process according to claim 1 in which the mixture has a 10 to 150% stoichiometric excess of oxygen over the fuel gas.

11. The process according to claim 10 in which the mixture has an 80 to 150% stoichiometric excess of oxygen over the fuel gas.

12. The process according to claim 11 in which the hydrogen is present in at least the stoichiometric amount by volume in respect of the species being combusted.

13. The process according to claim 12 in which the hydrogen is present in at least twice the stoichiometric amount by volume in respect of the species being combusted.

14. The process according to claim 12 in which the hydrogen is present in at least five times the stoichiometric amount by volume in respect of the species being combusted.

15. The process according to claim 13 in which the hydrogen is present in at least five times the stoichiometric amount by volume in respect of the species being combusted.

16. The process according to claim 1 in which the chamber comprises a heated metal tube.

17. The process according to claim 16 in which the chamber is heated by electrical means.

18. The process according to claim 17 in which the hydrogen and the oxygen are introduced into the gas stream prior to the stream being injected in to the chamber.

19. The process according to claim 18 in which the mixture has a 10 to 150% stoichiometric excess of oxygen over the fuel gas.

20. The process according to claim 19 in which the mixture has an 80 to 150% stoichiometric excess of oxygen over the fuel gas.

21. The process according to claim 20 in which the hydrogen is present in at least the stoichiometric amount by volume in respect of the species being combusted.

22. The process according to claim 21 in which the hydrogen is present in at least twice the stoichiometric amount by volume in respect of the species being combusted.

23. The process according to claim 21 in which the hydrogen is present in at least five times the stoichiometric amount by volume in respect of the species being combusted.

24. The process according to claim 22 in which the hydrogen is present in at least five times the stoichiometric amount by volume in respect of the species being combusted.

25. The process according to claim 1 in which the chamber is heated by electrical means.

26. The process according to claim 25 in which the hydrogen and the oxygen are introduced into the gas stream prior to the stream being injected in to the chamber.

27. The process according to claim 26 in which the mixture has a 10 to 150% stoichiometric excess of oxygen over the fuel gas.

28. The process according to claim 27 in which the mixture has an 80 to 150% stoichiometric excess of oxygen over the fuel gas.

29. The process according to claim 28 in which the hydrogen is present in at least the stoichiometric amount by volume in respect of the species being combusted.

30. The process according to claim 29 in which the hydrogen is present in at least twice the stoichiometric amount by volume in respect of the species being combusted.

31. The process according to claim 29 in which the hydrogen is present in at least five times the stoichiometric amount by volume in respect of the species being combusted.

32. The process according to claim 30 in which the hydrogen is present in at least five times the stoichiometric amount by volume in respect of the species being combusted.
